(19) United States
(12) Patent Application Publication
(10) Pub. No.: US 2013/0321205 A1
(43) Pub. Date: Dec. 5, 2013

(54) Method And Apparatus For Analyzing A System Design Having A Phased Array Antenna

(71) Applicants: Mark J. Beals, Fort Wayne, IN (US); Edgar J. Martinez, Fort Wayne, IN (US); Jacob Kim, Dallas, TX (US); Ajay Subramanian, Florence, MA (US); William F. Skalenda, Plano, TX (US); Robert W. Alm, Windham, NH (US); Lee A. McMillan, Fort Wayne, IN (US)

(72) Inventors: Mark J. Beals, Fort Wayne, IN (US); Edgar J. Martinez, Fort Wayne, IN (US); Jacob Kim, Dallas, TX (US); Ajay Subramanian, Florence, MA (US); William F. Skalenda, Plano, TX (US); Robert W. Alm, Windham, NH (US); Lee A. McMillan, Fort Wayne, IN (US)

(73) Assignee: Raytheon Company, Waltham, MA (US)

(21) Appl. No.: 13/486,340

(22) Filed: Jun. 1, 2012

(51) Int. Cl. H01Q 3/00

(52) U.S. Cl. 342/372

(57) ABSTRACT

Disclosed subject matter is directed to techniques and systems for analyzing a system design having a phase array antenna. In at least one implementation, component models of individual components of the phased array antenna may be provided. The component models may be arranged as a multi-dimensional lookup table (LUT) in some embodiments. A single-channel model of antenna performance may be synthesized for the system design based on the component models. An analysis of the performance of the system design may then be performed using the single-channel model of antenna performance.

### FIELD

The subject matter disclosed herein relates generally to systems design and, more particularly, to techniques and tools for analyzing a system design that includes a phased array antenna under realistic operational conditions.

### BACKGROUND

During the design process of radar systems, communication systems, and other systems that include phased-array antennas, it is often difficult to validate system performance under realistic operational conditions. This is because systems that include phased-array antennas are relatively complex and are thus difficult to characterize (or model) using computer models with a degree of accuracy sufficient to accurately validate system performance under realistic operational conditions. Consequently, in order to validate a system design, one or more prototypes of the system typically are built and tested to determine whether system performance is adequate in real world situations.

One drawback to this approach, however, is that if system performance problems are identified at this stage (i.e. after a prototype is built), significant engineering resources may be needed to identify a root cause of a failure. Often, the results of a failure analysis will lead to a partial or full redesign of the system, which can involve a significant increase in system development costs.

In some scenarios, system design failures may be related to the component requirements of a design. In many cases, the component requirements of a design may be derived from an assumed set of operational conditions. This can lead to the components of a phased array antenna being over or under specified. When these components are later integrated into a phased array antenna system, in many instances the system performance may fail to meet predicted specifications. Variations in component performance can lead to manufacturing yield variations with some manufactured systems not being able to meet specifications.

In view of the above, there is a need for tools and techniques that allow system designers to more accurately analyze system designs that include phased array antennas under realistic operating conditions. There is also a need for tools and techniques that allow designers to validate and/or modify system and component level requirements of a system design prior to implementation.

### SUMMARY

Tools and techniques are provided for analyzing system designs that include a phased array antenna. The tools and techniques allow designers to determine how a design is going to perform under realistic operating conditions before an actual system is manufactured and tested. In this manner, potential problem areas may be more accurately identified and remedied before significant system construction costs are incurred. In some implementations, the tools and techniques may allow component requirements associated with a system design to be analyzed, and possibly modified, during the design process. The effects of component performance variations and tolerances may also be analyzed during the design process in some implementations to determine whether stricter limits on performance variation should be imposed. Techniques may also be provided for analyzing a system design in the presence of one or more specific interference sources.

In one implementation, a machine implemented method to analyze a system design that includes a phased array antenna may be provided. More specifically, the method may include: (a) providing component models of individual components of the phased array antenna; (b) synthesizing a single-channel model of antenna performance for the system design based on the component models, using beamforming techniques; and (c) performing single-channel system performance analysis for the system design using the single-channel model of antenna performance.

In another implementation, a system to analyze a system design that includes a phased array antenna may be provided. The system may include: (a) one or more memories to store parametric model data describing individual components of the phased array antenna of the system design; and (b) one or more processors to: (i) synthesize a single-channel model of antenna performance for the system design using the parametric model data; and (ii) perform a single-channel system performance analysis for the system design using the single-channel model of antenna performance.

### BRIEF DESCRIPTION OF THE DRAWINGS

FIG. 1 is a block diagram illustrating an example system for use in analyzing a system design that includes a phased array antenna in accordance with an implementation;

FIGS. 2 and 3 are portions of a flowchart illustrating an example method for analyzing a system design having a phased array antenna in accordance with an implementation; and

FIG. 4 is a block diagram illustrating an example computing system architecture that may be used to implement features described herein in one or more implementations.

### DETAILED DESCRIPTION

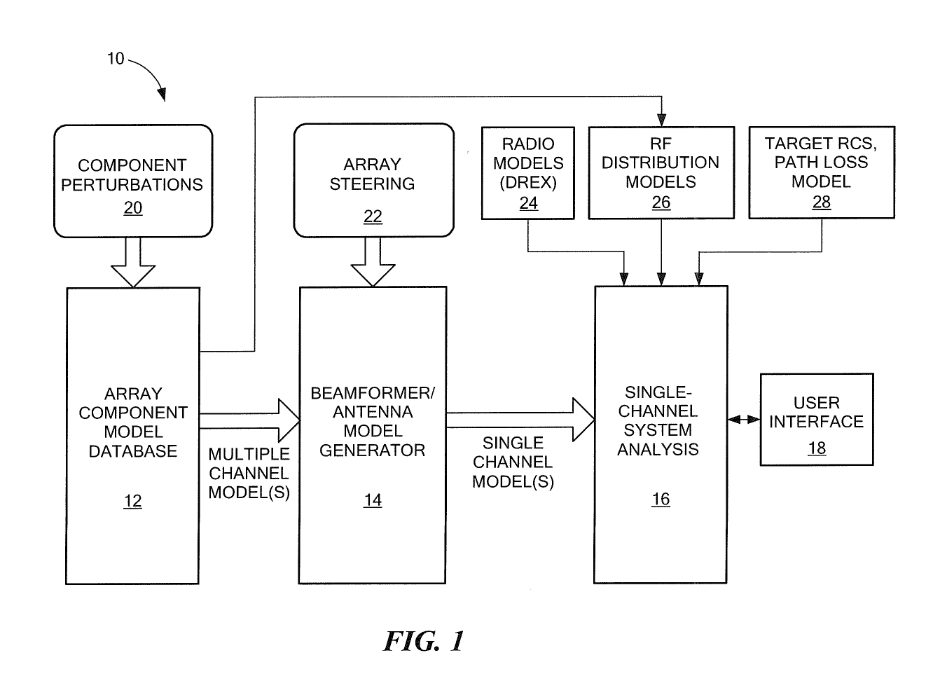

FIG. 1 is a block diagram illustrating an example system 10 for use in analyzing a system design that includes a phased array antenna in accordance with an implementation. As illustrated, the system 10 may include: a component model database 12, a beamformer/antenna model generator 14, a single-channel system analysis unit 16, a user interface 18, a component perturbation unit 20, an array steering controller 22, a radio model database 24, an RF distribution (RFD) model database 26, and target RCS and path loss model database 28. Component model database 12 may include models for components of a system design that are associated with a phased array antenna. Beamformer/antenna model generator 14 retrieves multi-channel phased array information from component model database 12 and uses it to synthesize a reduced order (e.g., single-channel) model of antenna performance utilizing beamforming techniques. Single-channel system analysis unit 16 is a system analysis tool that is capable of analyzing one or more performance metrics of a single-channel system design using the single-channel model of antenna performance generated by the beamformer/antenna model generator 14. User interface 18 acts as a user control interface between an operator and analysis system 10.

Because a phased array antenna is a multi-channel structure, system analysis techniques that are intended to analyze single-channel systems have limited use when analyzing system designs that include a phased array antenna. For this reason, single-channel system analysis unit 16 would not normally be useful to analyze the performance of a system design that includes a phased array antenna.

However, by using beamformer/antenna model generator 14 to synthesize a reduced order, single-channel model of antenna performance from the voluminous information in component model database 12, analysis system 10 is able to use single-channel system analysis unit 16 to analyze one or more aspects of the system design. The results generated by single-channel system analysis unit 16 may be used to determine whether, for example, one or more changes need to be made to the system design to achieve a desired level of system performance. In many cases, these changes may be made while the system is still in the design phase and before any hardware has been built. As will be appreciated, this ability can lead to significant savings during a system design phase over previous techniques that required prototypes to be built and tested to analyze design performance.

As described above, component model database 12 stores models for components of a system design that are associated with a phased array antenna. As such, component model database 12 may include models for components associated with, for example, transmit-receive channels, antenna elements, sub-arrays, feed networks, and/or any other subsystem associated with a phased array antenna. In at least one implementation, parametric modeling techniques may be used to generate component models for some or all of the various components. Non-linear components may be modeled using non-linear component parameters (e.g., X parameters, etc.) in some implementations. By using non-linear models for selected components, the analysis system 10 may be better able to predict system performance over a wide range of operating conditions. In some implementations, non-linear models of all radio frequency (RF), intermediate frequency (IF), and local oscillator (LO) amplifiers and mixers of a system design are included within the component model database 12. In different embodiments, the component models may be generated using modeling techniques, through direct component measurements, or both. The models may be arranged and stored within one or more memories of system 10.

Beamformer/antenna model generator 14 uses beamforming techniques to synthesize a reduced order, single-channel model of antenna performance using data from component model database 12. The model generated by beamformer 14 will, in most implementations, correspond to a particular beam direction and beam shape of the phased array antenna. In such implementations, to get an accurate picture of system performance over the many possible beam directions and beam shapes that the phased array antenna is capable of generating, beamformer 14 may have to generate different antenna performance models for each of a number of different beam directions/shapes. In one possible approach, beamformer/antenna model generator 14 may first receive array steering information from array steering unit 22 that identifies a desired beam direction and/or shape to be analyzed. Beamformer/antenna model generator 14 may then retrieve information from component model database 12 that is needed to generate the desired beam in the phased array antenna. Beamformer 14 may then use this information to generate an antenna pattern for the phased array antenna and/or other antenna model information. Beamformer/antenna model generator 14 may be implemented within one or more digital processors of analysis system 10.

In some implementations, some or all of component model database 12 may be organized as a multi-dimensional lookup table (LUT). The multi-dimensional LUT may include entries for some or all of the different system states of interest of the system design. The multi-dimensional LUT may be arranged in a convenient and efficient format for retrieval of model information as a function of, for example, frequency, DC control voltages, input power, phase state, attenuator state, and/or other parameters. The entries in the multi-dimensional LUT may be swept across many different operational parameters of the phased array antenna. For example, the entries may be swept across frequency, across a number of attenuator states and phase states, and/or across one or more operational signal levels, such as a power amplifier gate voltage, power amplifier drain voltage, base plate temperature, and/or others. Each swept variable may add one new outer loop or dimension to the multi-dimensional LUT. As will be appreciated, the size of the multi-dimensional LUT may become very large in some implementations.

In various implementations that utilize a multi-dimensional LUT, beamformer/antenna model generator 14 may select a single entry from component model database 12 (i.e., from the multi-dimensional LUT) for each active element of the phased array. As described previously, the beamformer/antenna model generator 14 may receive a command from, for example, antenna steering unit 22 as to a particular beam direction and beam shape to be analyzed. Beamformer/antenna model generator 14 may then select entries from the component model database 12 to generate an antenna pattern for the desired beam direction/shape, frequency, and/or electrical drive levels. The selected entries may be used to populate, for example, an input file for delivery to a phased array pattern analysis application. The pattern analysis application may use the input file to generate one or more phased array beam patterns that may be used as a single-channel antenna model in further system analysis operations. In general, the pattern analysis application may synthesize and aggregate the independent component models that were selected from the multi-dimensional LUT to create an aggregate model of the phased array antenna. In some implementations, some or all of the functionality of beamformer/antenna model generator 14 may be implemented using a high level programming language that is capable of performing numerical programming techniques (e.g., Matlab, etc.), although lower level programming languages may be used in other implementations.

By using a multi-dimensional LUT, the beamforming operation is able to use data produced with parametric variations using detailed models at the component level. This allows the beamformer to more accurately account for phenomena that might not otherwise be captured. In addition, use of a multi-dimensional LUT can make the analysis process more efficient for an analyst. For example, if an LUT is not used, the calculation of the performance of each transmit/receive (T/R) channel would need to be performed during the beamforming operation. When an LUT is used, on the other hand, the T/R channel calculations can be performed beforehand, during the generation of the LUT. Thus, when an analyst eventually performs an analysis, they can vary parameters much more quickly and efficiently to investigate the effects of parameter variations on system performance.

In general, single-channel system analysis unit 16 may be operative for analyzing various aspects of a system design to determine whether the system design is capable of meeting specified performance metrics. The analysis may be performed using the single-channel antenna performance model generated by beamformer 14, as well as other input information. For example, the single-channel system analysis unit 16 may use models from radio model database 24, RF distribution (RFD) model database 26, target RCS and path loss model database 28, and/or other sources to perform a single-channel system analysis. In at least one embodiment, information within RF distribution (RFD) model database 26 may be derived from component model database

As a first step, single-channel system analysis unit 16 may be operative for analyzing the performance of the system design in the absence of interference. In at least one implementation, however, single-channel system analysis unit 16 may also include functionality for performing single-channel interference and/or interoperability analysis for a system design being analyzed. That is, if a system design is found to operate in a desired fashion in the absence of interference, it may next be desirable to know how well the system design performs in the presence of one or more known interferers. In at least one implementation, single-channel system analysis unit 16 may make use of a COMSET interference analysis tool to perform the single-channel interference analysis of the system design. The COMSET interference analysis tool is a proprietary interference analysis tool owned by Raytheon Corporation that was developed to perform, among other things, interference and interoperability analysis for single-channel systems and system designs. Some of the features of the COMSET interference analysis tool are described in U.S. Pat. No. 8,086,187 to Davis et al. which is hereby incorporated by reference in its entirety. It should be appreciated, however, that single-channel system analysis unit 16 may perform other forms of single-channel system analysis in addition to, or as an alternative to, single-channel interference and/or interoperability analysis in various implementations. Single-channel system analysis unit 16 may be implemented within, for example, one or more digital processors of analysis system 10.

Component perturbation unit 20 is operative for controllably altering component models within component model database 12 to analyze, for example, the effects of component tolerances upon the performance of a system design. In many cases, a base design may operate in a desired manner when components are used that are close to their nominal design values. However, when manufacturing variations result in components that vary more widely from nominal design values, some system designs may experience a large increase in manufactured units that fail to meet performance specifications. Component perturbation unit 20 enables a user to simulate variations in component tolerances during a design to determine, for example, how robust a system design may be to individual component performance variations. After component models within component model database 12 have been varied, beamformer/antenna model generator 14 may be used to synthesize a single-channel model of antenna performance for one or more beam directions and/or shapes. The single-channel model of antenna performance may then be used by single-channel system analysis unit 16 to perform an analysis of system performance with the modified component values. In some implementations, a modified multi-dimensional LUT may be generated using the modified component models for use by the beamformer/antenna model generator 14 to synthesize the single-channel antenna performance model.

A described above, user interface 18 may be used as a control interface between an operator and analysis system 10. As such, user interface may include any of various input/output devices used in conventional computer systems (e.g., a display, keyboard, mouse, trackball, etc.). User interface 18 may also include a processor and corresponding software that enable a user to manage an analysis operation for a particular system design. For example, in various implementations, user interface 18 may allow users to specify which beam angles and beam shapes of a phased array antenna are to be analyzed, which types of interference to analyze, which component models to vary to test system robustness to component performance variation, and/or other analysis tasks. In some implementations, a graphic user interface (GUI) may be provided to allow a user to control an analysis operation.

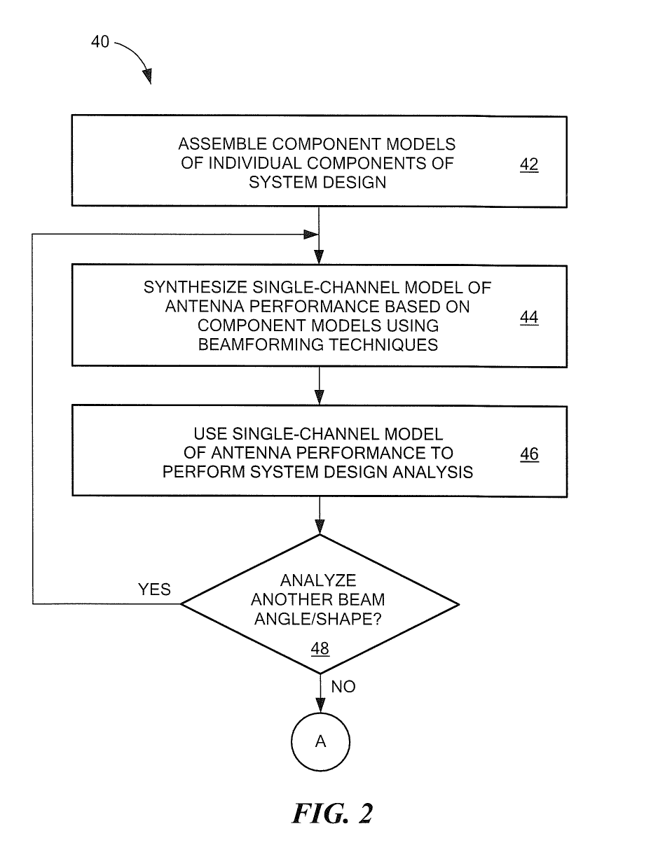

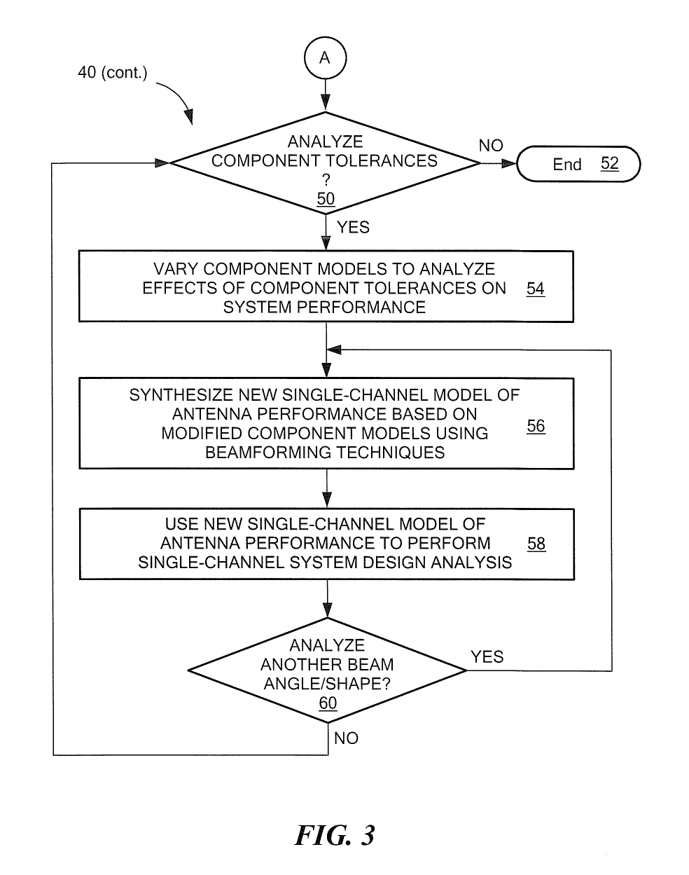

FIGS. 2 and 3 are portions of a flow diagram showing a method 40 for analyzing a system design having a phased array antenna in accordance with an implementation. The rectangular elements (typified by element 44 in FIG. 2) are herein denoted “processing blocks” and may represent computer software instructions or groups of instructions. It should be noted that the flow diagram of FIGS. 2 and 3 represents one exemplary embodiment of the design described herein and variations in such a diagram, which generally follow the process outlined, are considered to be within the scope of the concepts, systems, and techniques described and claimed herein.

Alternatively, the processing blocks may represent operations performed by functionally equivalent circuits such as a digital signal processor circuit, an application specific integrated circuit (ASIC), or a field programmable gate array (FPGA). Some processing blocks may be manually performed while other processing blocks may be performed by a processor. The flow diagram does not depict the syntax of any particular programming language. Rather, the flow diagram illustrates the functional information one of ordinary skill in the art may require to fabricate circuits and/or to generate computer software to perform the processing required of a particular apparatus. It should be noted that many routine program elements, such as initialization of loops and variables and the use of temporary variables, are not shown. It will be appreciated by those of ordinary skill in the art that unless otherwise indicated herein, the particular sequence described is illustrative only and can be varied without departing from the spirit of the concepts described and/or claimed herein. Thus, unless otherwise stated, the processes described below are unordered meaning that, when possible, the sequences shown in FIGS. 2 and 3 can be performed in any convenient or desirable order.

Referring now to FIGS. 2 and 3, the example method 40 for analyzing a system design having a phased array antenna will be described. Models of individual components associated with the phased array antenna of the system design may first be assembled (block 42). The models may be generated using component modeling techniques, through direct component measurements, or by a combination of techniques. In some implementations, parametric analysis techniques are used to model the components. Some or all of the non-linear components may be modeled using non-linear models. In some implementations, a multi-dimensional LUT may be generated having records for some or all of the system states of interest related to the phased array antenna. As described above, the multi-dimensional LUT may be arranged in a convenient and efficient format for retrieval of model information as a function of, for example, frequency, DC control voltages, input power, phase state, attenuator state, and/or other parameters.

A single-channel model of antenna performance may next be synthesized based on the component models using beamforming techniques (block 44). The single-channel model may be based on a pre-determined beam direction and shape of the phased array antenna. In an implementation that uses a multi-dimensional LUT, the synthesis of the single-channel model may involve selecting states for each element of the array from the multi-dimensional LUT based, at least in part, on phase and attenuation values needed for beam formation. In one possible approach, a single entry of a multi-dimensional LUT is selected for each active element of a phased array antenna. It should be understood, however, that a particular analysis may not involve all antenna elements in the phased array (i.e., some elements may be inactive). The selected states may then be used to generate an antenna pattern for the phased array antenna. In some implementations, the antenna pattern may serve as the single-channel model of antenna performance. Other techniques may alternatively be used.

The single-channel model of antenna performance may next be used to perform further analyses of the system design (block 46). These analyses may include performance testing to determine whether the system design is capable of achieving predetermined performance goals for the design in the absence of interference. In some implementations, the single-channel model of antenna performance may also be used to perform single-channel interference analysis of the system design. During the single-channel interference analysis, the performance of the system design may be analyzed in the presence of one or more specified interference signals. The interference signals to be used in the analysis may be user-specified. For example, a user may know of one or more potential interference sources that may be operative within the vicinity of a system in a real world setting. The user can specify these interference sources as part of the single-channel interference analysis. As described above, in some embodiments, a COMSET interference analysis tool may be used to perform the single-channel interference analysis. Other or alternative types of single-channel analyses may also be performed using the single-channel model of antenna performance in other implementations.

It may next be determined whether another beam direction/shape of the phased array antenna is to be analyzed (block 48). If another beam direction/shape is to be analyzed (block 48-Y), then method 40 may return to block 44 where another single-channel model of antenna performance is synthesized for the new beam direction/shape. Further single-channel analyses of the system design may then be performed using the new single-channel model of antenna performance (block 46). This process may then be repeated for each additional beam direction/shape of the phased array antenna to be analyzed.

If no additional beam direction/shapes are to be analyzed (block 48-N), it may next be determined if component tolerances of the system design are to be analyzed (block 50 of FIG. 3). If component tolerances are not to be analyzed (block 50-N), the method 40 may terminate (block 52). If component tolerances are to be analyzed (block 50-Y), then the component models may be varied to analyze the effects of variations in component performance on system performance (block 54). A single-channel model of antenna performance may then be synthesized based on the new component models using beamforming techniques (block 56). In some implementations, a new multi-dimensional LUT may be generated using the modified component models. Additional single-channel system analyses may then be performed using the new single-channel model of antenna performance (block 58).

It may next be determined whether another beam direction/shape of the phased array antenna is to be analyzed for the current modified component models (block 60). If another beam direction/shape is to be analyzed (block 60-Y), then method 40 may return to block 56 where another single-channel model of antenna performance is synthesized for the new beam direction/shape. Further single-channel analyses of the system design may then be performed using the new single-channel model of antenna performance (block 58). This process may then be repeated for each additional beam direction/shape of the phased array antenna to be analyzed. The method 40 may then return to block 50 where it is determined whether further component tolerance analysis is to be performed. If no further component tolerance analysis is to be performed (block 50-N), the method 40 may terminate (block 52). If further component tolerance analysis is to be performed (block 50-Y), the above-described process may be repeated (blocks 54, 56, 58, 60).

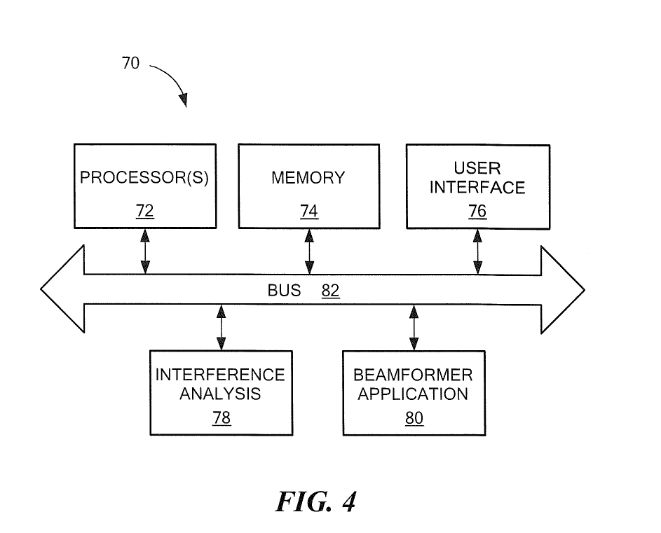

FIG. 4 is a block diagram illustrating an example computing system architecture 70 that may be used to implement features described herein in one or more implementations. As illustrated, the architecture 70 may include: one or more digital processors 72, a memory 74, a user interface 76, an interference analysis unit 78, and a beamformer application 80. A bus 82 and/or other structure(s) may be provided for establishing interconnections between various components of computing system architecture 70. Digital processor(s) 72 may include one or more digital processing devices that are capable of executing programs or procedures to provide functions and/or services for a user. Memory 74 may include one or more digital data storage systems, devices, and/or components that may be used to store data and/or programs for other elements of computing system architecture 70. User interface 76 may include any type of device, component, or subsystem for providing an interface between a user and architecture 70.

Interference analysis unit 78 may include any type of programmed device or structure that is capable of performing single-channel interference analysis for a system design. Interference analysis unit 78 may derive input information from one or more databases, lookup tables, or other data structures stored in memory 74 to perform interference analysis. Beamformer application 80 may include functionality for generating single-channel antenna performance models for phased array antennas using beamforming techniques. Although illustrated as separate units, in some implementations, interference analysis unit 78 and beamformer application 80 may be implemented in software within digital processor(s) 72.

Digital processor(s) 72 may include, for example, one or more general purpose microprocessors, digital signals processors (DSPs), controllers, microcontrollers, application specific integrated circuits (ASICs), field programmable gate arrays (FPGAs), programmable logic arrays (PLAs), programmable logic devices (PLDs), reduced instruction set computers (RISCs), and/or other processing devices or systems, including combinations of the above. Digital processor(s) 72 may be used to, for example, execute an operating system for a corresponding computing system. Digital processor(s) 72 may also be used to, for example, execute one or more application programs for a corresponding computing system. In addition, digital processor(s) 72 may be used to implement, either partially or fully, one or more of the processes or techniques described herein in some implementations.

Memory 74 may include any type of system, device, or component, or combination thereof, that is capable of storing digital information (e.g., digital data, computer executable instructions and/or programs, etc.) for access by a processing device or other component. This may include, for example, semiconductor memories, magnetic data storage devices, disc based storage devices, optical storage devices, read only memories (ROMs), random access memories (RAMs), non-volatile memories, flash memories, USB drives, compact disc read only memories (CD-ROMs), DVDs, Blu-Ray disks, magneto-optical disks, erasable programmable ROMs (EPROMs), electrically erasable programmable ROMs (EEPROMs), magnetic or optical cards, and/or other digital storage suitable for storing electronic instructions and/or data. In at least one implementation, memory 74 may be used to store some or all of the component model database 12 of FIG. 1. It should be appreciated that the computing system architecture 70 of FIG. 4 represents one possible example of an architecture that may be used in an implementation. Other architectures may alternatively be used, including architectures that use wireless and/or wired networks to provide communications between separately located computers.

TABLE 1
VAR Vg=−2.8
VAR att=0
VAR ph=0
BEGIN ACDATA
# AC( MHZ S RI R 50 FC 1 0 )
! small signal s-parameter
% F n11x n11y n21x n21y n12x n12y n22x n22y
8500.000000 1.032952e−10 1.015611e−11 326.105149 351.165719 5.956935e−24 −1.539890e−23 0.187111 −1.807224e−02
9500.000000 1.082698e−10 1.597156e−11 −358.765236 −553.535204 1.558588e−25 −1.654367e−23 0.222123 −1.016014e−02
1.050000e+04 1.143372e−10 1.633440e−11 542.879581 −334.438444 −9.321857e−24 −1.892044e−23 0.223760 −0.153608
! power dependent s-parameter
% F
8500.000000
% P1 P2 n11x n11y n21x n21y n12x n12y n22x n22y
−30.000000 23.487699 1.032950e−10 1.015633e−11 260.169341 394.399343 1.373589e−23 3.112553e−23 0.187111 −1.807224e−02
−20.000000 32.175374 1.032898e−10 1.015950e−11 117.181789 388.958542 1.674181e−23 2.944253e−23 0.187111 −1.807224e−02
−10.000000 36.123580 1.032389e−10 1.019054e−11 88.701097 181.911882 1.930572e−23 2.766018e−23 0.187111 −1.807224e−02
% F
9500.000000
% P1 P2 n11x n11y n21x n21y n12x n12y n22x 1122y
−30.000000 26.543465 1.082695e−10 1.597210e−11 −244.568318 −625.590006 −2.997287e−22 −2.393319e−22 0.222123 −1.016014e−02
−20.000000 34.082661 1.082662e−10 1.597963e−11 −125.544571 −490.157082 −3.212481e−22 −1.989523e−22 0.222123 −1.016014e−02
−10.000000 36.640896 1.082327e−10 1.605357e−11 −82.854754 −198.182648 −3.314791e−22 −1.742860e−22 0.222123 −1.016014e−02
% F
1.050000e+04
% P1 P2 n11x n11y n21x n21y n12x n12y n22x n22y
−30.000000 26.375053 1.143381e−10 1.633551e−11 −205.175065 −626.034135 −2.881293e−23 1.291597e−22 0.223760 −0.153608
−20.000000 32.875704 1.143467e−10 1.634940e−11 −70.899935 −434.591634 −2.247514e−23 1.290748e−22 0.223760 −0.153608
−10.000000 35.069891 1.144274e−10 1.648000e−11 −64.914898 −167.098350 −1.904781e−23 1.288984e−22 0.223760 −0.153608
END ACDATA
BEGIN NDATA
# AC( MHZ S MA R 50 )
! noise parameters
% F NFMIN N11X N11Y RN
8500.000000 12.002646 7.116352e−12 3.588090 3.714648
9500.000000 12.001402 7.004952e−12 4.055673 3.713512
1.050000e+04 11.998150 6.831989e−12 4.699468 3.710546
END NDATA

Tables 1 and 2 illustrate portions of an example multi-dimensional LUT in accordance with an implementation. For purposes of clarity and to simplify illustration, the multi-dimensional LUT of Tables 1 and 2 is a relatively simple LUT having a small number of entries (e.g., only two phase/amplitude states are shown). In practice, multi-dimensional LUT's may be used that are multiple orders of magnitude larger in size and dimension and that have entries for all phase/amplitude states of interest. As illustrated in Tables 1 and 2, the multi-dimensional LUT includes entries for a number of different component parameters that are swept across frequency. More specifically, the multi-dimensional LUT includes entries for small signal s-parameters, power dependent

TABLE 2
VAR Vg=−2.8
VAR att=0
VAR ph=1
BEGIN ACDATA
# AC( MHZ S RI R 50 FC 1 0 )
! small signal s-parameter
% F n11x n11y n21x n21y n12x n12y n22x n22y
8500.000000 1.032914e−10 1.014429e−11 356.021477 289.879242 5.957155e−24 −1.540215e−23 0.187111 −1.807224e−02
9500.000000 1.082792e−10 1.597640e−11 −399.452918 −490.472447 1.582767e−25 −1.654202e−23 0.222123 −1.016014e−02
1.050000e+04 1.143277e−10 1.633324e−11 498.105362 −369.812854 −9.325371e−24 −1.891978e−23 0.223760 −0.153608
! power dependent s-parameter
% F
8500.000000
% P1 P2 n11x n11y n21x n21y n12x n12y n22x n22y
−30.000000 23.101872 1.032910e−10 1.014446e−11 299.545432 338.429251 1.366212e−23 3.1 16914e−23 0.187111 −1.807224e-02
−20.000000 31.910577 1.032861e−10 1.014752e−11 168.468045 356.199175 1.660814e−23 2.953377e−23 0.187111 −1.807224e-02
−10.000000 36.067226 1.032356e−10 1.017770e−11 108.628887 169.208510 1.926713e−23 2.769779e−23 0.187111 −1.807224e-02
% F
9500.000000
% P1 P2 n11x n11y n21x n21y n12x n12y n22x n22y
−30.000000 26.166188 1.082787e−10 1.597694e−11 −299.394815 −569.209269 −2.989200e−22 −2.405602e−22 0.222123 −1.016014e−02
−20.000000 33.867327 1.082754e−10 1.598458e−11 −173.275821 −462.175918 −3.203846e−22 −2.007225e−22 0.222123 −1.016014e−02
−10.000000 36.607667 1.082420e−10 1.605941e−11 −100.804922 −188.753677 −3.312813e−22 −1.746903e−22 0.222123 −1.016014e−02
% F
1.050000e+04
%P1 P2 n11x n11y n2lx n21y n12x n12y n22x n22y
−30.000000 26.183909 1.143283e−10 1.633433e−11 −254.889479 −591.911381 −2.891772e−23 1.291689e−22 0.223760 −0.153608
−20.000000 32.752306 1.143369e−10 1.634815e−11 −106.712436 −420.805650 −2.262387e−23 1.290906e−22 0.223760 −0.153608
−10.000000 35.055022 1.144167e−10 1.647841e−11 −76.280403 −161.886583 −1.905380e−23 1.289091e−22 0.223760 −0.153608
END ACDATA
BEGIN NDATA
# AC( MHZ S MA R 50 )
! noise parameters
% F NFMIN N11X N11Y RN
8500.000000 12.003326 7.132287e−12 3.567086 3.715268
9500.000000 12.001879 7.016612e−12 4.033237 3.713948
1.050000e+04 11.998109 6.831004e−12 4.702921 3.710508
END NDATA

s-parameters, and noise parameters at each of three different frequencies 8.5 GHz, 9.5 GHz, and 10.5 GHz. The portion of the multi-dimensional LUT in Table 1 corresponds to a first phase/amplitude state and the portion of the multi-dimensional LUT in Table 2 corresponds to a second phase/amplitude state. The multi-dimensional LUT may also be swept across the useable range of a power amplifier gate voltage (Vg). As described previously, additional dimensions may be added to the multi-dimensional LUT by sweeping the data across other parameters.

The techniques, systems, and devices described herein may be used in connection with any system design that includes a phased array antenna. This may include use in connection with, for example, radar system designs, communication system designs, wireless network designs, RFID system designs, and/or others. In some implementations, one or more of the techniques and/or processes described herein may be implemented as computer instructions stored on a computer readable medium. The computer readable medium may include any physical medium upon which computer instructions can be stored in a computer-readable fashion including, for example, semiconductor memories, magnetic data storage devices, disc based storage devices, optical storage devices, read only memories (ROMs), random access memories (RAMs), non-volatile memories, flash memories, USB drives, compact disc read only memories (CD-ROMs), DVDs, Blu-Ray disks, magneto-optical disks, erasable programmable ROMs (EPROMs), electrically erasable programmable ROMs (EEPROMs), magnetic or optical cards, and/or other digital storage.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Having described exemplary embodiments of the invention, it will now become apparent to one of ordinary skill in the art that other embodiments incorporating these concepts may also be used. The embodiments contained herein should not be limited to disclosed embodiments, but rather should be limited only by the spirit and scope of the appended claims. All publications and references cited herein are expressly incorporated herein by reference in their entirety.

What is claimed is:

1. A machine implemented method to analyze a system design that includes a phased array antenna, comprising:
providing component models of individual components of the phased array antenna, wherein providing component models includes providing a multi-dimensional lookup table (LUT) having entries corresponding to a number of system states of interest of the phased array antenna with each dimension of the multi-dimensional LUT corresponding to a different operational parameter of the phased array antenna swept across a predetermined range of values;
synthesizing a single-channel model of antenna performance for the system design based on the component models, using beamforming techniques; and
performing single-channel system performance analysis for the system design using the single-channel model of antenna performance.

2. The method of claim 1, wherein:
the multi-dimensional LUT is arranged to allow for efficient retrieval of model information as a function of one or more operational parameters of the phased array antenna.

3. The method of claim 2, wherein:
the one or more operational parameters includes at least one of the following: frequency, DC control voltage, input power, phase state, attenuator state, and base plate temperature.

4. The method of claim 1, wherein synthesizing a single-channel model of antenna performance includes:
determining a desired beam direction and beam shape for the phased array antenna;
selecting entries from the multi-dimensional LUT to achieve the desired beam direction and beam shape; and
processing the selected entries to generate an antenna pattern for the phased array antenna.

5. The method of claim 4, wherein:
selecting entries from the multi-dimensional LUT includes selecting one entry for each active element of the phased array antenna.

6. The method of claim 1, wherein:
providing component models includes providing non-linear parameter models of one or more components of the phased array antenna.

7. The method of claim 6, wherein:
providing component models includes providing X-parameters for one or more components of the phased array antenna.

8. The method of claim 1, further comprising:
varying the component models to generate modified component models for use in analyzing component tolerance effects on system performance;
synthesizing a new single-channel model of antenna performance for the system design based on the modified component models, using beamforming techniques; and
performing single-channel system performance analysis for the system design using the new single-channel model of antenna performance.

9. The method of claim 1, wherein:
performing single-channel system performance analysis for the system design using the single-channel model of antenna performance includes performing single-channel interference analysis to determine an effect of one or more interference signals on system performance.

10. A system to analyze a system design that includes a phased array antenna, comprising:
one or more memories to store parametric model data describing individual components of the phased array antenna, wherein at least some of the parametric model data is stored as a multi-dimensional lookup table (LUT) having entries corresponding to a number of system states of interest of the phased array antenna; and
one or more processors to:
synthesize a single-channel model of antenna performance for the system design using the parametric model data; and
perform a single-channel system performance analysis for the system design using the single-channel model of antenna performance.

11. The system of claim 10, wherein:
the parametric model data describing individual components of the phased array antenna includes non-linear parametric model data.

12. The system of claim 10, wherein:
the parametric model data describing individual components of the phased array antenna includes X-parameter data.

13. The system of claim 10, wherein the one or more processors use beamforming techniques to synthesize the single-channel model of antenna performance.

14. The system of claim 13, wherein the one or more processors are configured to:
determine a desired beam direction and beam shape for the phased array antenna;
select entries from the multi-dimensional LUT to achieve the desired beam direction and beam shape; and
process the selected entries to generate an antenna pattern for the phased array antenna.

15. The system of claim 10, wherein:
each dimension of the multi-dimensional LUT corresponds t_{o a} different operational parameter of the phased array antenna swept across a predetermined range of values.

16. The system of claim 10, wherein:
the multi-dimensional LUT is arranged to allow for efficient retrieval of model information as a function of one or more operational parameters of the phased array antenna.

17. The system of claim 10, further comprising:
a component perturbation unit to modify parametric model data stored in the one or more memories to generate modified parametric model data for use in analyzing component tolerance effects on system performance;
wherein the one or more processors are configured to:
synthesize a new single-channel model of antenna performance for the system design using the modified parametric model data; and
perform single-channel system performance analysis for the system design using the new single-channel model of antenna performance.
